(19) United States
(12) Patent Application Publication
(10) Pub. No.: US 2005/0072012 A1
(43) Pub. Date: Apr. 7, 2005

(54) Dual axis flexible rule

(76) Inventor: Dan E. Corcoran, Beaverton, OR (US)

Correspondence Address: DELLETT AND WALTERS, P. O. BOX 2786, PORTLAND, OR, 97208-2786, US

(21) Appl. No.: 10/982,562

(22) Filed: Nov. 5, 2004

Related U.S. Application Data
(63) Continuation-in-part of application No. 10/206,262, filed on Jul. 25, 2002.

(51) Int. Cl. B43L 7/00

(52) U.S. Cl. 33/483

(57) ABSTRACT

A dual axis flexible rule is predisposed to a curved configuration, but is adapted to be pressed more flat in use. The rule includes a curved portion and a substantially non-curved or flat portion, and enables transcribing straight lines onto curved surfaces.

### BACKGROUND OF THE INVENTION

This application is a continuation in part of U.S. patent application Ser. No. 10/206,262.

This invention relates to straight-line rules, and more particularly to a dual axis rule adapted to enable underlining in books with ease.

Students, engineers, and others often have the need to underline portions of text in books, or to draw straight lines in logbooks, for example. In the conventional manner, such persons would employ a straight ruler, for example, to underline the portion of the book. However, such a ruler and method of using it have the disadvantage in that the book will typically be curved towards the center thereof when the book is in the open position, as a result of the bindings of the book along its spine. Therefore, to get a straight-line underline, it becomes necessary for the user to push down and flatten the curvature of the book in order to be able to draw a straight line from margin to margin on a page. As will be understood, with thicker books this became less possible, as the thicker the book, the greater the curve. Also, a thicker book would be less likely to be able to be compressed to the point that it would provide a substantially flat surface for drawing a line. Therefore, it becomes difficult to obtain a substantially straight underline or one that appeared neat and precise. In books with tightly bound pages or those with margins that are very close to the paper edges, it becomes especially difficult to draw such an underline. In an attempt to get past this problem, a user may try to roll a straight ruler around the curved surface, while simultaneously drawing the line using the ruler edge as a guide. This process can be difficult to accomplish and can annoy the user.

### SUMMARY OF THE INVENTION

In accordance with the present invention, a flexible dual axis rule is provided which has a first portion that is generally curved in its normal undisturbed state and a second portion that is generally straight or uncurved in its normal state. The rule is flexible so that it can be pressed to conform to a particular shape of a curved surface that is being underlined.

Accordingly, it is an object of the present invention to provide an improved dual axis flexible rule for enabling easy underlining in books or the like.

Another object of the present invention is to provide an improved aid to transcribe a straight line to a curved surface.

It is another object of the present invention to provide an improved rule that enables easy underlining in books without regard to whether the lines of the book are square to the page.

It is yet another object of the present invention to provide an improved dual axis flexible rule that is adapted for use to assist in underlining in books with varying types of bindings and thicknesses.

Still a further object of the present invention is to provide a dual axis rule that is pre-disposed to be in a non-flat configuration.

Yet another object of the invention is to provide an improved rule to enable transcribing straight lines in books with close margins or in books that are tightly bound.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a perspective view of a dual axis rule in accordance with the present invention;

FIG. 2 is a side view of the flexible rule of FIG. 1;

FIG. 3 is a perspective view of the dual axis rule according to the invention in use, as it is employed in underlining in a bound book;

FIG. 4 is a partial sectional view of the dual axis rule in use in a book, taken along line 4-4 of FIG. 3;

FIG. 5 is a perspective view of a closed book with the dual axis rule placed between pages thereof;

FIG. 6 is a perspective view of an alternate embodiment of the dual axis rule with rule markings thereon; and

FIG. 7 illustrates preferred embodiment angles and radius of the dual axis rule.

### DETAILED DESCRIPTION

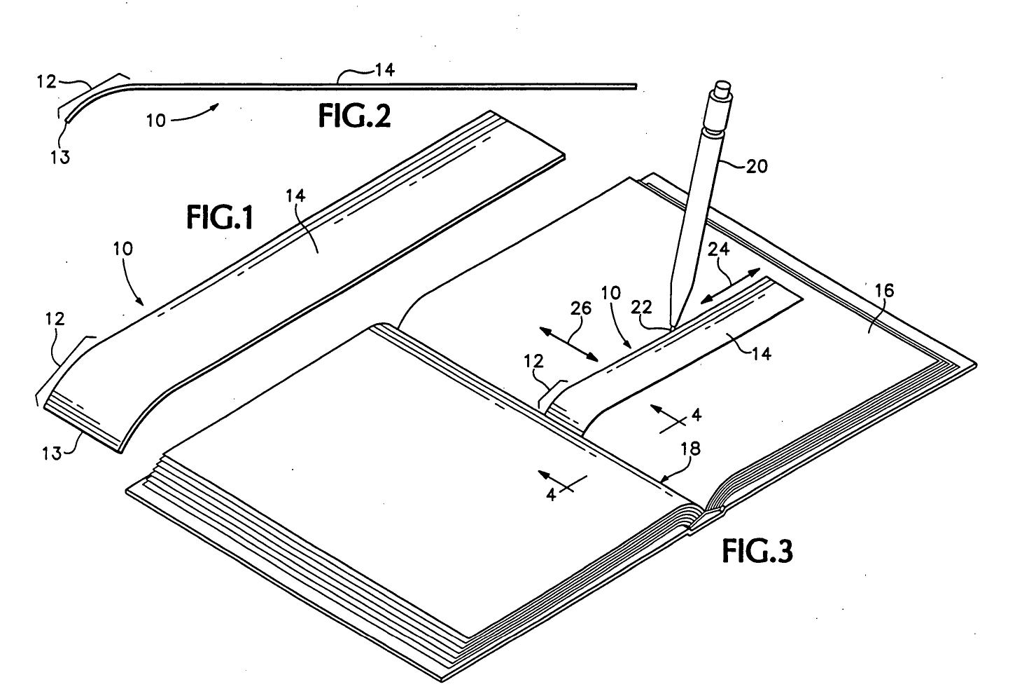

According to a preferred embodiment, the present invention comprises an elongate relatively thin flexible member having a portion which is normally curved, and a somewhat substantially longer portion, which is normally flat or uncurved. Referring to FIG. 1, which is a perspective view of a dual axis flexible rule in accordance with the invention, the rule 10 comprises a first curved portion 12 and a second flat or straight elongate portion 14. The rule has an overall rectangular configuration in the illustrated embodiment, being substantially wider than it is thick, and even substantially longer than it is wide. In the view of FIG. 1, the rule is in its substantially resting state, wherein no external pressure or bias is applied thereto. The rule assumes the illustrated position in such an unbiased state. Thus, it is predisposed to a bent or non-flat configuration. At the leftmost end of the rule (as considered in the view of FIG. 1) at the distal end of the curved portion 12, is a substantially straight butt end 13.

FIG. 2 is a side view of the rule 10 of FIG. 1, further illustrating the substantially curved or arcuate portion 12 and the elongate flat or non-arcuate portion 14. The butt end 13 of the rule when considered as in FIG. 2 is substantially square with respect to the two sides of the rule, the two sides of the rule being substantially straight. This however, is not a requirement. The rule is made of a flexible material, and is preset or predispositioned to be curved in the configuration as shown in FIG. 1 and FIG. 2. The preferred thickness of the rule is twenty to fifty one-thousandths of an inch, although thicker or thinner configurations are possible. The typical width of the rule is one-half to three-quarters inch, while the length may vary from several inches to six inches or more. As noted hereinabove, typically the end of the rule adjacent the curved portion is substantially square relative to the sides of the rule along the elongate portion thereof. The rule is typically made of polystyrene, polycarbonate, polyurethane, polyvinyl chloride, or other such materials. It may, however, be made of other materials, such as steel, for example, but in such a case will be much thinner.

Referring now to FIG. 3, which is a perspective view of the flexible dual axis rule in accordance with the invention when used to underline portions of a book, the rule 10 is placed within the open book 16 in the manner illustrated in FIG. 3, such that the butt end 13 of the rule at the curved portion 12 thereof is positioned near the center spine region 18 of the open book. A pen 20 or other such marking device is then positioned as illustrated and the user may then draw a line by running the tip 22 of the pen along the extent of one of the two sides along the direction of the arrow 24 as shown, using the rule as a straight edge guide. As the user wishes to make further lines at different positions along the page, the rule is slid upwardly or downwardly along the page in the direction of arrow 26, to reposition the rule for generating an additional line in a different location.

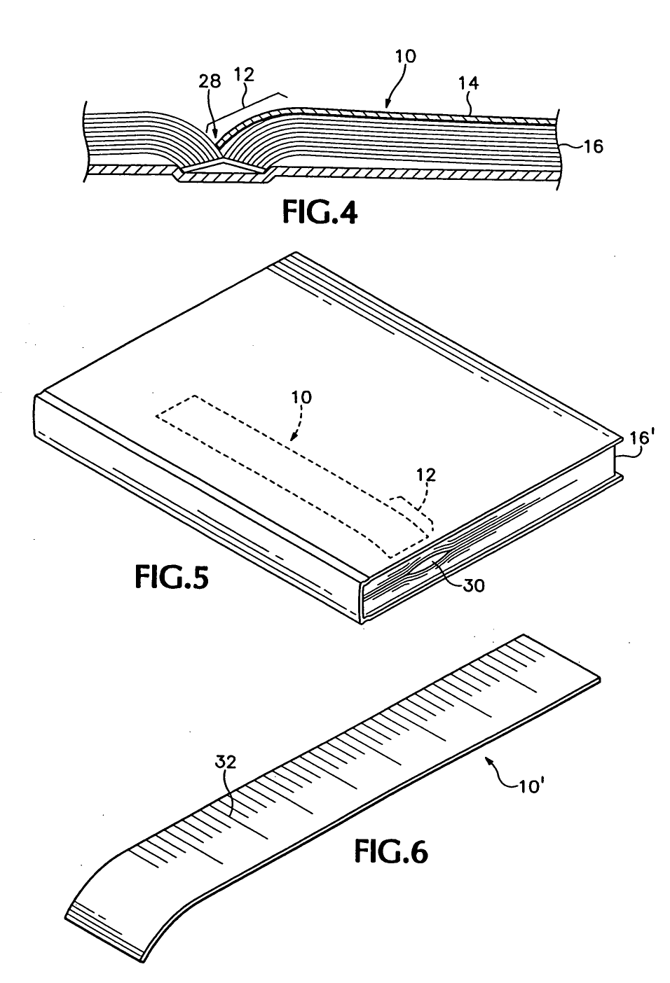

Referring now to FIG. 4, which is a perspective view taken along line 4-4 of FIG. 3, advantageous functional aspects of the dual axis rule in accordance with the invention may be better understood. As may be observed in FIG. 4, in the placement of the rule against the book 16, the substantially flat portion 14 of the rule will lay across the page of the book. The arcuate or curved portion 12 of the rule will extend down into the curved open portion of the book page towards the spine where the pages are bound to the spine. However, as may be observed in FIG. 4, the butt end 13 which is at the left most edge (in the illustration FIG. 4) of the curved portion of the rule will ride against the opposite page curved portion of the book on the opposite side of the book, as indicated by arrow 28 in FIG. 4. Thus, rather than riding in the very center portion of the crack between the pages of the open book, as would be instinctively thought to be the operational mode, the dual axis flexible rule's butt end 13 is actually riding along the page of the opposite side of the book. The curved portion of the opposite page thus provides a guiding edge against which the rule may ride as it is moved up and then down in the direction of arrow 26 (FIG. 3) by the user. This configuration enables the rule to be guided substantially straight down the page or to remain substantially perpendicular, even if the butt end 13 of the rule is not necessarily square or if the portions of the book to be underlined are not square relative to the page of the book or relative to the depression or crack defined by the center spine region 18 in the open book. Further, as the user presses downward on the rule, the curved portion will flex and the butt end 13 will tend to lift upwardly, so as to accommodate the downward pressure and maintain contact with the curved portion of the opposite side of the book.

In other configurations, and in the preferred embodiment, in use, the butt end of the rule does not even ride against the opposite page portion, nor does it need to. The curved face inner surface of the regions 12 riding along the curvature of the book page across which the rule is being place is sufficient for guiding the rule, whether the butt end is touching the opposite side or not.

Referring now to FIG. 5, which is a perspective view of a closed book with the rule inserted therein, the rule 10, illustrated in phantom in FIG. 5, may also be used as a bookmark by insertion between respective pages of a book 16′. In the illustration of FIG. 5, the curved portion 12 of the rule is positioned near the peripheral edge of the particular pages between which the rule has been placed and the pre-curved bias of the rule results in the slight gap portion 30 that is visible in the drawing. The advantage thereby provided is that when the user picks up the book, the predisposed curvature of the rule will tend to urge the pages apart where the rule is positioned, which increases the likelihood that the book will easily and automatically open to the desired marked pages.

Referring now to FIG. 6, which is a perspective view of an alternate embodiment of the dual axis rule 10′, graduated markings 32 may suitably be provided whereby the rule also doubles as a measurement tool, in addition to acting as an aid to transcribing a straight line to a curved surface. These markings may comprise, for example, metric length measurements, English standard measurements, or other suitable markings (such as type size markings, for example).

In manufacturing the flexible rule, the rule is generally thermal formed or thermal set. It may be cut, for example from a sheet of the desired material having suitable flexing properties. As mentioned hereinabove, these materials comprise, for example, polycarbonate, polystyrene, polyurethane, polyvinyl chloride, or the like. The preferred thickness of the material is between twenty and fifty one-thousandths of an inch. Thicker material can be used, but it becomes less flexible as the material becomes thicker. Such a less flexible rule still can be advantageously used, however. In the case of using steel, for example, the preferred thickness of the rule will be less than 10/1000 ths of an inch. The rules are cut to the desired length and width, and then are placed in a press or other device to bend the curved portion 12 into the rule. The press suitably also provides the capability of heating the material for a period of time, in the case of polycarbonate for example, to ensure that the desired curved configuration then is the predisposed state of the finished rule.

While the illustrated embodiments employ substantially square ends relative to the straight side portions thereof (particularly the butt end 13), alternative embodiments may be constructed having other configurations, such as a more angled configuration, for the purpose of inscribing diagonal lines on a curved object, for example. Thus, if the butt end 13 of the curved portion is at a 45° angle relative to the sides of the elongate portion of the rule, lines at an angle of 45° to the page may be inscribed, for example. Also, while the preferred embodiment is a dual axis rule, a three dimension rule is also possible, for use with a stencil, for example, for drawing the stencil pattern on a non-flat surface.

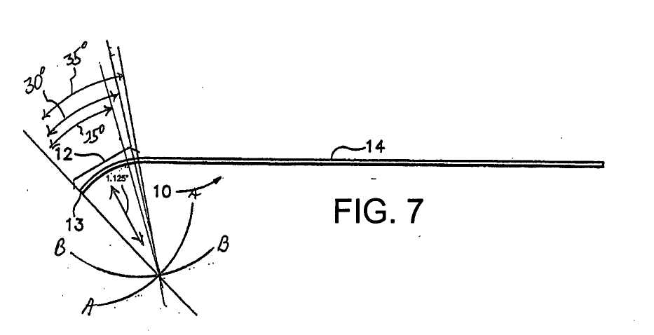

FIG. 7 illustrates selected angles and arc in preferred embodiments. The angles are suitably between 25 and 35 degrees with a 1.125 inch arc radius, wherein 30 degrees, plus or minus approximately 5 degrees is the preferred angle. The arc radius may be between 1 to 1.25 inches typically, 1.125 inches being preferred. Applicant has discovered that this radius and curve, together with the flexibility of the rule, allow the rule to adapt and conform to the curved portion of an open book when the book is open, without having to apply any substantial amount of pressure to the rule, allowing easy use, even with a single handed operation, without having to force the rule to conform to the book. Typically, the curved portion of an open book when laid flat is 2.25 times the thickness of a binding (with some variation depending on the stiffness of the paper and binding type). The rule's flexibility mitigates the variations in different books and allows accommodation of many book sizes and types.

The material that the rule is made from is suitably polystyrene, polycarbonate, polyurethane, and polyvinyl chloride with a thickness of between 20 and 50 one thousandths of an inch. Alternatively, steel having a thickness of less than 10 one thousandths of an inch may be employed.

The flexibility and thin profile enable to rule to be closed in a book without damage to the book, yet the rule will spring back to its preset resting curvature configuration when the book is re-opened.

Therefore, in accordance with the present invention, a dual axis flexible rule is provided that acts as an aid to transcribe a straight line to a curved surface. This curved surface may comprise a book having a curved portion at its bindings, for example. The rule is preset or predispositioned to be curved, but is flexible, in contrast to prior art rules which might be flexible, but are preset to be substantially flat. The configuration of the rule enables it to be used in transcribing lines in books whether they are tightly bound or not, or whether they have close margins. Thus, it is possible to draw a straight line without having to roll a flat ruler around the curved surface. The particular length of the curved portion relative to the straight portion will vary, with a longer curve being available for use in thicker books which would thereby have a steeper or deeper curved portion.

While plural embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

1. A dual axis rule having first and second ends, comprising:
an arcuate portion defined at the first end of the rule and adapted for riding along a curved portion of a surface; and
an elongate substantially non-arcuate portion, extending from said arcuate portion to the second end and defining said second end as a substantially straight portion, wherein said arcuate and elongate portions are adjoined to form a unitary member,
wherein at least said arcuate portion of said rule is flexible, whereby said rule is adapted to conform to the curve of the surface of a portion of a page of an open book adjacent the spine of the book against which the rule is held for translation therealong.

2. A dual axis rule according to claim 1, wherein at least one of said arcuate portion or said non-arcuate portion carries ruled markings thereon.

3. A dual axis rule according to claim 1, wherein said arcuate portion and said elongate substantially non-arcuate portion comprise material selected from the group consisting of polystyrene, polycarbonate, polyurethane, and polyvinyl chloride.

4. A dual axis rule according to claim 3, wherein said material has a thickness of between 20 and 50 one thousandths of an inch.

5. A dual axis rule according to claim 1, wherein said arcuate portion and said elongate substantially non-arcuate portion comprise steel having a thickness of less than 10 one thousandths of an inch.

6. A dual axis rule according to claim 1, wherein said arcuate portion comprises an arc of between 25 to 35 degrees with a radius of between approximately 1.0 and 1.25 inches.

7. A dual axis rule according to claim 6, wherein said arc is approximately 30 degrees and said radius is approximately 1.125 inches.

8. A dual axis rule, comprising:
a first end portion pre-disposed to be in a curved but substantially flexible state and adapted for placement on a curved portion of a page of a book in a region adjacent the spine of the book and for sliding along said curved portion in a direction substantially parallel to the axis of the spine of the book; and
a second end portion opposite said first end portion, pre-disposed to be in a substantially non-curved state.

9. A dual axis rule according to claim 8, wherein said second portion is substantially flexible.

10. A dual axis rule according to claim 8, wherein said first and second portions are substantially flexible.

11. A dual axis rule according to claim 8, wherein said first portion and said second portion comprise material selected from the group consisting of polystyrene, polycarbonate, polyurethane, and polyvinyl chloride.

12. A dual axis rule according to claim 11, wherein said material has a thickness of between 20 and 50 one thousandths of an inch.

13. A dual axis rule according to claim 8, wherein said first portion and said second portion comprise steel having a thickness of less than 10 one thousandths of an inch.

14. A dual axis rule according to claim 8, wherein said first end portion defines an arc of between 25 to 35 degrees with a radius of between approximately 1.0 to 1.25 inches.

15. A dual axis rule according to claim 14, wherein said arc is approximately 30 degrees and said radius is approximately 1.125 inches.

16. A multi-axis rule having first and second ends, comprising:
an arcuate portion defining the first end; and an elongate substantially non-arcuate portion which includes and defines the second end, wherein said arcuate and elongate portions are adjoined to form a unitary member, wherein at least one of said arcuate portion and said non-arcuate portion is flexible.

17. A multi-axis rule according to claim 16, wherein said wherein said arcuate portion and said elongate substantially non-arcuate portion comprise material selected from the group consisting of polystyrene, polycarbonate, polyurethane, and polyvinyl chloride.

18. A multi-axis rule according to claim 17, wherein said material has a thickness of between 20 and 50 one thousandths of an inch.

19. A multi-axis rule according to claim 16, wherein said wherein said arcuate portion and said elongate substantially non-arcuate portion comprise steel having a thickness of less than 10 one thousandths of an inch.

20. A multi-axis rule according to claim 16, wherein said arcuate portion comprises an arc of between 25 to 35 degrees with a radius of between approximately 1.0 and 1.25 inches.

21. A multi-axis rule according to claim 20, wherein said arc is approximately 30 degrees and said radius is approximately 1.125 inches.
